(19) United States
(12) Patent Application Publication
(10) Pub. No.: US 2007/0189289 A1
(43) Pub. Date: Aug. 16, 2007

(54) Apparatus, method and computer program product providing frequency domain multiplexed multicast and unicast transmissions

(75) Inventors: Frank Frederiksen, Klarup (DK); Preben Mogensen, Gistrup (DK); Olav Tirkkonen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/645,470

(22) Filed: Dec. 26, 2006

Related U.S. Application Data
(60) Provisional application No. 60/754,437, filed on Dec. 27, 2005.

(51) Int. Cl. H04L 12/56; H04J 3/26

(52) U.S. Cl. 370/390; 370/432

(57) ABSTRACT

A method is provided for applying frequency domain multiplexing of unicast and multicast services on a single carrier, such that both services can operate at the same time, and may be received with the same RF front end and A/D converter. In order to reduce subcarrier interference between unicast and multicast tones a guardband is introduced between the unicast and multicast bands, where the guardband can be fixed or variable within a sub-frame. Also disclosed is a device and computer program product operable with the device.

### CROSS REFERENCE TO RELATED APPLICATIONS

This patent application claims priority under 35 U.S.C. §119(e) from Provisional Patent Application No. 60/754,437, filed Dec. 27, 2005, the disclosure of which is incorporated by reference herein in its entirety.

### TECHNICAL FIELD

The exemplary and non-limiting embodiments of this invention relate generally to wireless communications systems and, more specifically, relate to the transmission of unicast and multicast information streams to a receiver.

### BACKGROUND

The following abbreviations are herewith defined:
3GPP third generation partnership project
ADC analog to digital converter
BW base station (also referred to as a Node B)
BA bandwidth
CP cyclic Prefix
FDM frequency domain multiplexing
FAT fast fourier transform
ICI inter-carrier interference
ISI inter-symbol interference
OFDM orthogonal frequency division multiplex
RF radio frequency
RRM radio resource management
TDM time division multiplexing
TTI transmit time interval
UE user equipment
UTRAN universal terrestrial radio access network

The so-called evolved UTRAN (E-UTRAN) is currently a study item within the 3GPP. For the E-UTRAN system OFDM has been selected as the multiple access scheme for the downlink (i.e., in the direction from the BS to the UE).

Two types of data transmission can be considered: unicast (to single users or very small groups of users), and multicast (broadcast type of messages to a larger group of users subscribing to a certain service). The current assumption is that unicast will be implemented such that seven OFDM symbols are transmitted within a sub-frame having a duration of 0.5 milliseconds (ms), while multicast messages will be transmitted using only six OFDM symbols within a 0.5 ms sub-frame.

The multicast approach based OFDM will typically require that the BSs (or Node Bs) be time synchronized such that the data messages received from neighboring BSs will be decodable with a simple FFT operation. One implementation, when considering the multiplexing of unicast and multicast technologies, would use time multiplexing (i.e., TDM), such that certain sub-frames are reserved for multicast traffic, while other sub-frames are reserved for unicast traffic. However, it can be shown that time multiplexing of the two services within a single sub-frame would not bring any gain to the system, but rather would place limitations and requirements on the coordination of the network to facilitate the multiplexing operation.

One of the disadvantages of the use of TDM arises from the expectation that the multicast and unicast services may not demand the same requirements for transmission power. Another problem is that some UEs may have reduced RF bandwidth capability. For example, a particular UE may be only capable of receiving a signal with a 10 MHz BW, while the cellular system bandwidth may be, for example, 20 MHz. As a result, if the multicast and unicast services are time multiplexed then spectrum will be wasted since the multicast transmission must be limited to 10 MHz.

Thus far a default proposal has been to multiplex unicast and multicast services in the time domain on a single carrier on a per sub-frame basis (see Qualcomm: “Channel structure for E-UTRA MBMS evaluation”, R1-050901, London, August 2005). FIG. 2a shows this technique.

An alternative approach would use dedicated carriers for unicast and multicast, respectively. However, this approach would require placing two receivers in the UE, which is disadvantageous at least with regard to increased space, cost and power consumption requirements.

### SUMMARY OF THE INVENTION

In an exemplary aspect of the invention a method is provided for sending a multicast transmission over a first plurality of sub-carriers of a carrier, sending a unicast transmission over a second plurality of sub-carriers of the carrier, and interposing a guardband between the first plurality of sub-carriers and the second plurality of sub-carriers of the carrier.

In accordance with another exemplary embodiment of the invention, there is provided a program of machine-readable instructions, tangibly embodied on an information bearing medium and executable by a digital data processor, to perform actions including placing a multicast signal over a first plurality of sub-carriers of a carrier, placing a unicast signal over a second plurality of sub-carriers of the carrier, interposing a guardband between the unicast sub-carriers and the multicast sub-carriers, and transmitting the carrier signal.

In accordance with another exemplary embodiment of the invention, a network element includes a processor configured to allocate a multicast signal to a first plurality of sub-carriers of a carrier, to allocate a unicast signal to a second plurality of sub-carriers of the carrier, and to allocate a guardband signal to a third plurality of sub-carriers interposed between the first plurality of sub-carriers and the second plurality of sub-carriers; and a transmitter coupled to the processor to transmit the carrier signal.

In accordance with another exemplary embodiment of the invention, a user equipment includes a receiver configured to receive a plurality of sub-carriers on a carrier, and a processor coupled to the receiver to process a first plurality of sub-carriers allocated to a multicast signal, to process a second plurality of sub-carriers allocated to a unicast signal and to process a third plurality of sub-carriers that form a guardband signal interposed between the first plurality of sub-carriers and the second plurality of sub-carriers on the carrier.

In another exemplary embodiment of the invention there is provided an integrated circuit comprising a first circuit operable to accept a carrier signal comprising a first plurality of sub-carriers, a second plurality of sub-carriers, and a third plurality of sub-carriers comprising a guardband interposed between the first plurality of sub-carriers and the second plurality of sub-carriers, where the guardband comprises x sub-carriers, where x can be fixed or variable from sub-frame to sub-frame; a second circuit operable to sample the sub-carriers on the carrier signal, comprising isolating the guardband signal; a third circuit operable to digitize the sampled sub-carriers; a fourth circuit operable to process the digitized samples; and a fifth circuit comprising at least one signal type receiver circuit operable to receive the processed signals.

In yet another exemplary embodiment of the invention there is provided an electronic device comprising first circuit means for allocating a first plurality of sub-carriers comprising a multicast signal on the carrier signal, second circuit means for allocating a second plurality of sub-carriers comprising a unicast signal on the carrier signal, third circuit means for allocating a third plurality of sub-carriers comprising a guardband signal interposed between the first plurality of sub-carriers and the second plurality of sub-carriers on the carrier signal, where the guardband comprises x sub-carriers, where x is fixed or variable from sub-frame to sub-frame, and fourth circuit means operable to transmit the first, second and third plurality of sub-carriers on the carrier signal.

### BRIEF DESCRIPTION OF THE DRAWINGS

The foregoing and other aspects of embodiments of this invention are made more evident in the following Detailed Description, when read in conjunction with the attached Drawing Figures:

FIG. 1a shows a simplified block diagram of various electronic devices that are suitable for use in practicing the exemplary embodiments of this invention

FIG. 1b illustrates in greater detail the receiver of FIG. 1a, and shows unicast and multicast receivers capable of parallel operation.

FIG. 2a illustrates the principle underlying service multiplexing in the time domain and, in accordance with exemplary embodiments of this invention, FIG. 2b illustrates the principle underlying service multiplexing in the frequency domain.

FIG. 3 illustrates the principle underlying service multiplexing in the frequency domain.

FIGS. 4a, 4b and 4c depict methods to reduce loss due to the presence of a guard band.

FIG. 5 is a Table illustrating various parameters related to the EUTRAN downlink.

FIG. 6 illustrates a method of an exemplary embodiment of this invention underlying service multiplexing in the frequency domain.

FIG. 7 illustrates in even further detail the receiver of FIG. 1b, and shows unicast and multicast receivers capable of parallel operation.

FIG. 8 illustrates a flow diagram of an integrated circuit according to an exemplary embodiment of the invention.

### DETAILED DESCRIPTION

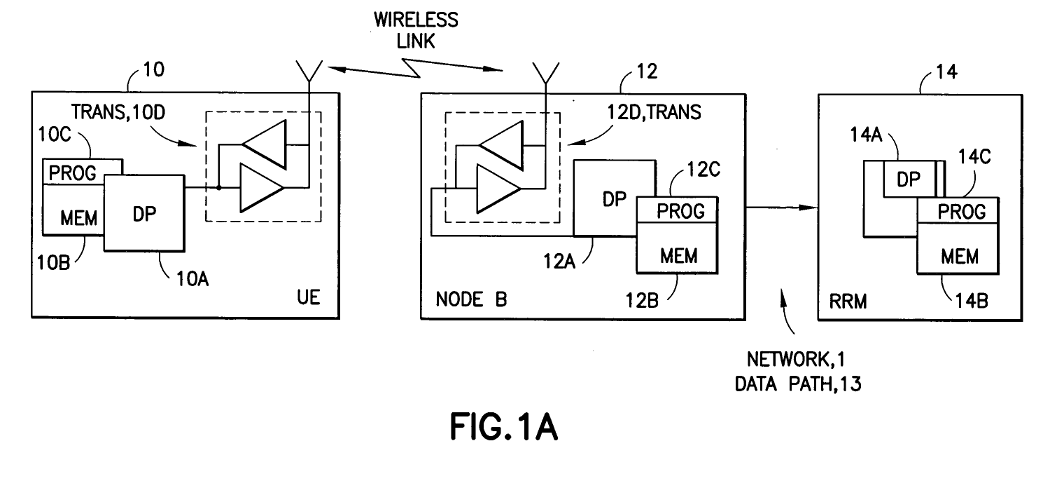

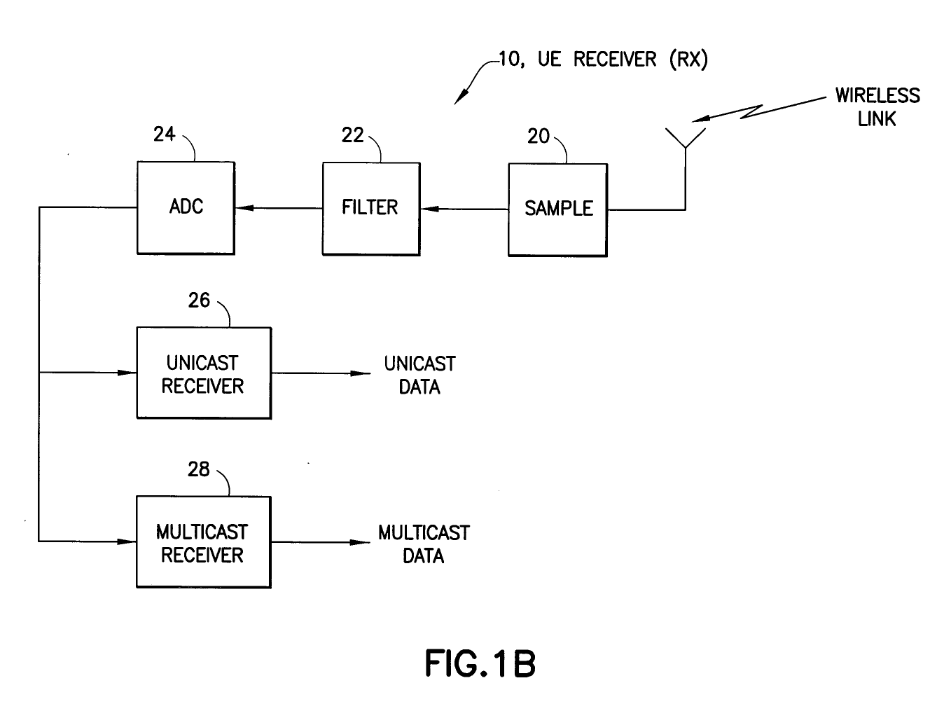

Reference is made first to FIG. 1a for illustrating a simplified block diagram of various electronic devices that are suitable for use in practicing the exemplary embodiments of this invention. In FIG. 1a a wireless network 1, such as an E-UTRAN network, is adapted for communication with a UE 10 via a Node B (base station) 12. The network 1 may include a RRM 14, which may be referred to as a serving RRM (SRRM), or another entity that handles control setup and other functions. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the RRM 14 that also includes a DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and other DPs such as the DP 12A, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

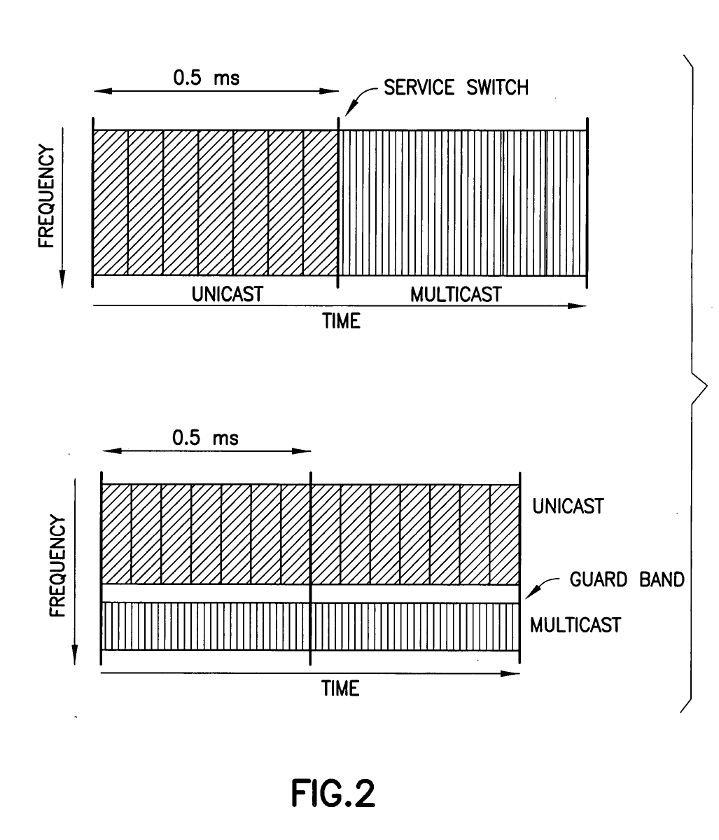

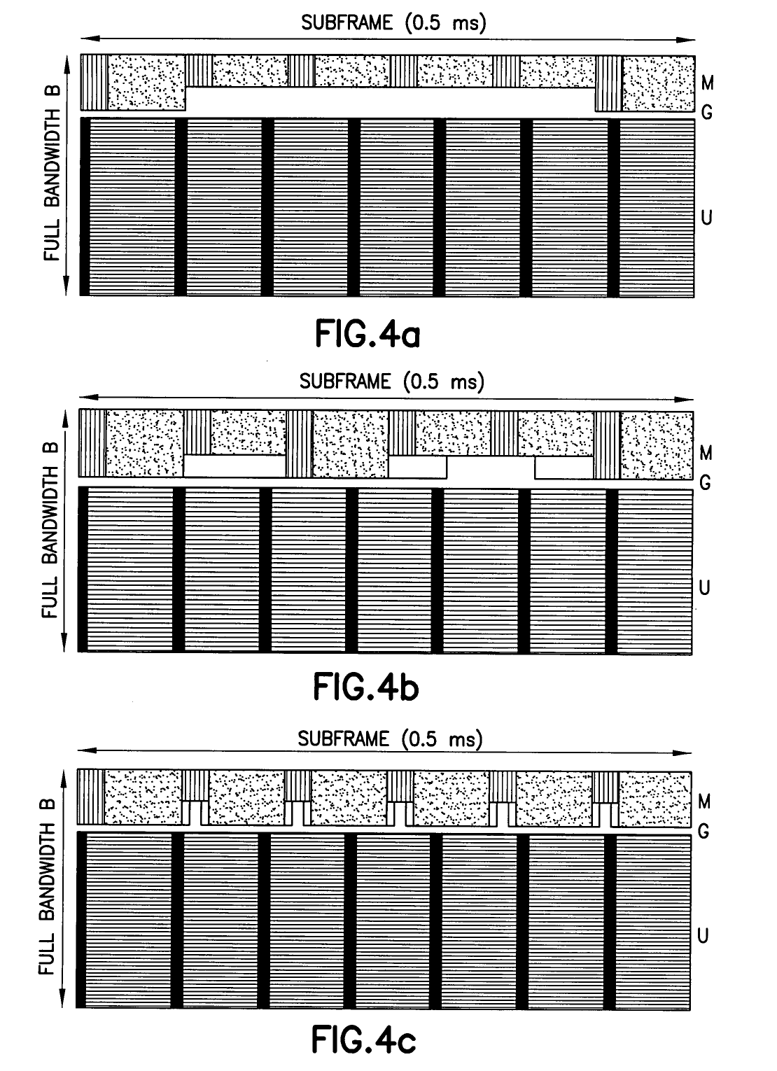

In accordance with exemplary embodiments of this invention, and referring to FIG. 2b, FDM of the unicast and multicast services on a single carrier is performed such that both services are capable of simultaneous operation, and can be received with the same RF front end and ADC of the UE 10 receiver (RX). In order to reduce sub-carrier interference between unicast and multicast tones a guardband is introduced between the unicast and multicast bands. The BW of the guardband may be fixed or it may be variable within a sub-frame (see FIGS. 4a, 4b and 4c, and the discussion of same below).

In accordance with exemplary embodiments of this invention both unicast and multicast services are simultaneously operable within the system bandwidth (single carrier). However, since these services operate using different values for the cyclic prefix, there is a potential loss of orthogonality between sub-carriers of the OFDM symbols. This potential loss of orthogonality is beneficially avoided by reserving as the guardband one or more sub-carriers between selected unicast and multicast bands. The guardband need not be larger than a few (e.g., four) sub-carriers, given the currently proposed E-UTRAN parameters.

Referring also to FIG. 1b, in the UE 10 receiver (RX), the full bandwidth signal is received from the wireless link and sampled 20, filtered 22 at RF and converted by ADC block 24. The output of the ADC 24 is applied to a unicast receiver 26 and also to a multicast receiver 28, as discussed below in further detail.

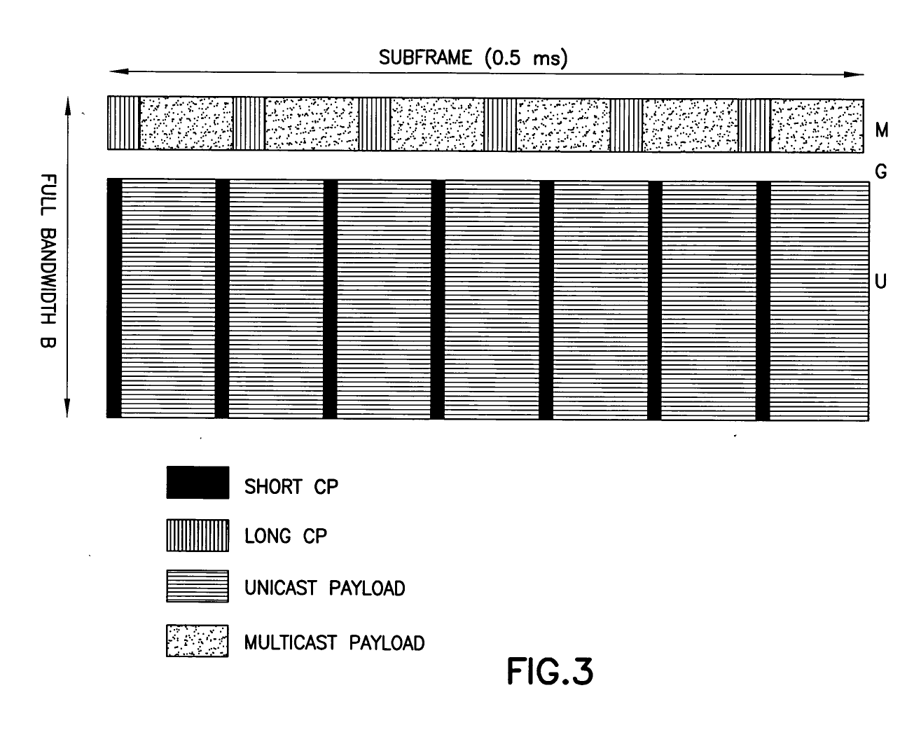

Consider as an example that the unicast service uses bandwidth U, the multicast service uses bandwidth M, and the guardband is G. Then U+M+G=B, where B is one of the EUTRA operating bandwidths. The operating bandwidth is distinguished from the system bandwidth (for example 20 MHZ), wherein the operational bandwidth is the actual used bandwidth, and may correspond to 90% of the system bandwidth (or in this case 18 MHZ). FIG. 3 depicts a FDM sub-frame with multicast and unicast services separated by guardband (G), according to the exemplary embodiments of this invention.

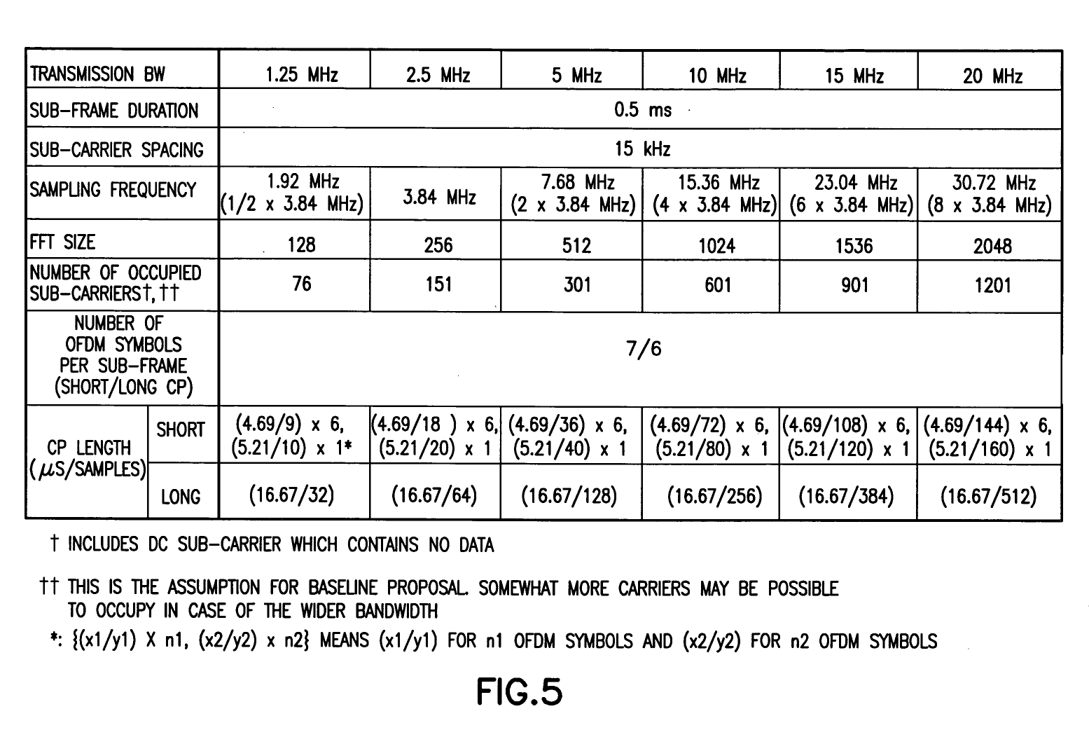

As non-limiting examples, the full bandwidths in EUTRA correspond to 75, 150, 300, 600, 900 or 1200 active sub-carriers (not counting the DC subcarrier) of 15 kHz, on 1.25, 2.5, 5, 10, 15 and 20 MHz system bandwidths, respectively, as shown in the table of FIG. 5 (which reproduces Table 7.1.1-1, Parameters for downlink transmission scheme, from 3GPP, “Physical Layer Aspects for Evolved UTRA”, TR 25.814, v 1.0.1 (2005-11).

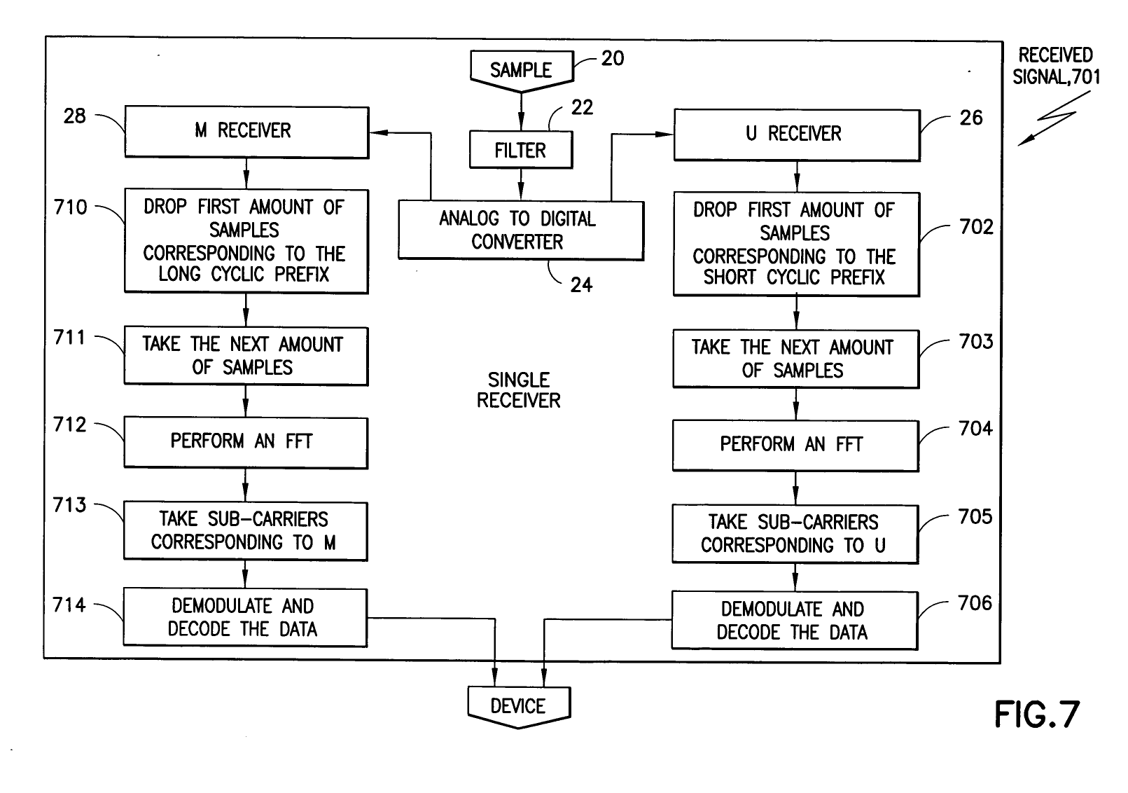

Referring to the receiver in FIG. 7, for illustrative purposes, and not by way of limitation, assume B=10 MHz, and further assume that the sampling rate of the received signal 701 is the FFT sampling frequency 15.36 MHz as illustrated in FIG. 5. In this case, in one sub-frame there are 7680 samples. In this case, the unicast receiver 26 drops the first 73 samples 702, corresponding to the short CP, and takes the next 1024 samples 703 and performs the FFT 704. The unicast receiver 26 takes the sub-carriers corresponding to U 705, and proceeds with demodulating and decoding the unicast data 706. The multicast receiver 28 drops the first 256 samples 710, corresponding to the long CP, and takes the next 1024 samples 711 and performs the FFT 712. The multicast receiver 28 takes the sub-carriers corresponding to M 713, and proceeds with demodulating and decoding the multicast data 714. While there may be an inter-carrier interference caused by U on M and vice versa, due to G it is made tolerable.

Note that while shown as two separate receivers, the unicast and multicast receivers 26, 28 may share one or more functional units and/or program code segments between them.

A user who is interested in both the unicast data and the multicast data processes the received samples with both the unicast receiver 26 and the multicast receiver 28. Note, however, that the allowed unicast and multicast subbands in B may be according to a EUTRAN parameterization for a smaller bandwidth so that, e.g., U=B′, where B′=<B. Thus for example, with B=10 MHz (600 subcarriers), U=B′ may take the value 600, and one or many of 300, 150, 75. With such an embodiment, a unicast user not interested in the multicast data may filter out the multicast signal at RF, and operate as if receiving only B′.

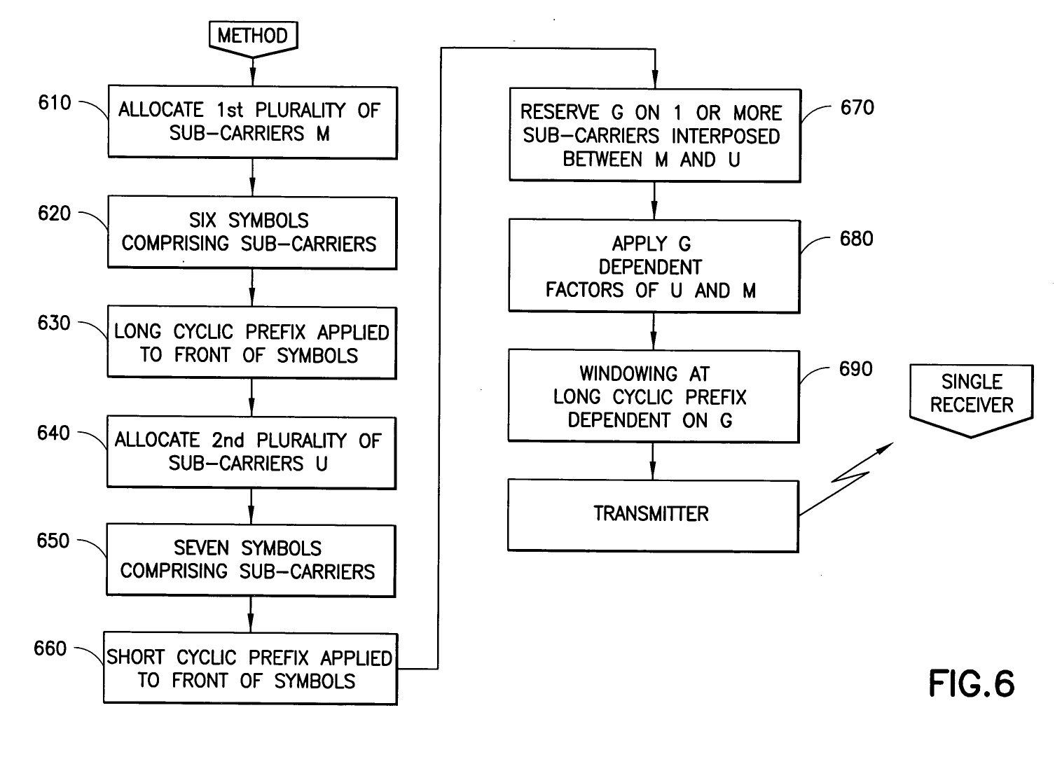

Referring to the method illustrated in FIG. 6, the FDM of the unicast 640 and multicast 610 services on a single carrier is performed such that both services are capable of simultaneous operation. In order to reduce sub-carrier interference between unicast and multicast tones the guardband 670 is introduced between the unicast 640 and multicast 610 bands. It may be that unicast is implemented such that seven OFDM symbols 650 are transmitted within a sub-frame having a duration of 0.5 milliseconds (ms), while multicast messages are transmitted using only six OFDM symbols 620 within a 0.5 ms sub-frame. Further, in the present EUTRAN parameters, the TTI length is 1 ms and thus may comprise two 0.5 milliseconds (ms) sub-frames.

Still referring to FIG. 6, in accordance with exemplary embodiments of this invention both unicast and multicast services are simultaneously operable within the system bandwidth (single carrier). However, since these services operate using different values for the cyclic prefix, a long cyclic prefix 630 for the multicast service and a short cyclic prefix 660 for the unicast service, there is a potential loss of orthogonality between sub-carriers of the OFDM symbols. This potential loss of orthogonality is beneficially avoided by reserving as the guard band 670 one or more sub-carriers between the selected unicast and multicast bands. The guard band need not be larger than a few (e.g., four) sub-carriers, given the currently proposed E-UTRAN parameters.

In addition, in FIG. 6, depending on what is the critical ICI, different solutions 680 can be applied. In addition, the overhead caused by G may be minimized by taking into account different symbols in a sub-frame, where multicast and unicast services are multiplexed, and cause different levels of ICI. Further, windowing 690 can be applied within the cyclic prefix of the multicast spectrum M, for all the symbols 620. Note that windowing 690 can reduce the tolerance of the signal to multipath delays. Windowing 690 and the application of G 680 can be depend on factors of U and M, as referenced in FIGS. 4a, 4b and 4c and is discussed in more detail below.

In FIG. 3 it can be seen that the payload part of the last symbol in the frame consists of exactly the same OFDM samples. Thus, the last multicast symbol would not suffer any interference from the unicast transmission, or the last unicast symbol from the multicast transmission. The longer cyclic prefix of the last multicast symbol, however, causes ICI to the payload of the sixth unicast symbol. Similarly, the first unicast symbol does not suffer any interference from the multicast transmission, whereas the first multicast symbol suffers from ICI from the second unicast symbol. These relationships can be used in advantage to reduce the overhead caused by G.

As was noted above, depending on what is the critical ICI, different solutions can be applied. In FIG. 4, the ICI caused by multicast on unicast is minimized. Thus in FIG. 4a, during the first and last multicast symbols, G is reduced to, for example, one subcarrier. In FIG. 4b, in addition to taking advantage of a narrower G for the last and first symbols, ramp up and ramp downs are incorporated. Note that ICI is caused by the broadening of the spectrum at the previous symbol/next CP jump or discontinuity. This jump can be smoothed by windowing, i.e., ramping up/down the signals so that abrupt changes are smoothed, and broadening of the spectrum is mitigated.

In FIG. 4c windowing is applied within the CP in a part W of the multicast spectrum M, for all the symbols. The residual guardband G′ is narrow. Note that windowing can reduce the tolerance of the signal to multipath delays. The gains of synchronous OFDM broadcast come from the fact that power can be gathered from multiple cells in perfect macro diversity, when the CP is long, and correspondingly ISI and ICI are minimized. Using part of the long CP (at least on part of the multicast band M) for windowing reduces these gains. However, if W is of the order of magnitude of G, and G′ is negligible, this permits using the part W of M for multicast transmission with slightly reduced macro diversity gains due to extended windowing. In general, overall multicast capacity is increased.

Based on the foregoing description it can be appreciated that the use of the exemplary embodiments of this invention provides a number of advantages. For example, support is provided for constant data rate multicast services. Further by example, the multicast portion is constant for a full (segment of a) network, thus having a reserved resource for this service, resulting in a need for less network planning and coordination. Further by example, the Node B 12 output power can be optimized to provide optimum power balancing between the unicast and multicast services, since these services may not have the same power requirements. Further by example, other interference control mechanisms such as, but not limited to, power sequencing in the frequency domain can be applied for the unicast sub-band. As another example of the advantages realized by the sue of the exemplary embodiments of this invention, support is provided for those UEs with reduced RF BW capability, without a corresponding loss of spectrum usage

Note that while some potential system capacity is consumed by the introduction of the guardband, the reduction is less than about 1% of the system bandwidth, at least for system bandwidths of 10 MHz or above.

In accordance with another exemplary embodiment of the invention, an electronic device includes a first circuit operable to allocate a first plurality of sub-carriers comprising a multicast signal to a carrier signal, a second circuit operable to allocate a second plurality of sub-carriers comprising a unicast signal to the carrier signal, a third circuit operable to allocate a third plurality of sub-carriers comprising a guardband signal to a carrier signal, where the circuits of the integrated circuit operates to interpose the third plurality of sub-carriers between the first plurality of sub-carriers and the second plurality of sub-carriers, and a fourth circuit operable to transmit the first, second and third plurality of sub-carriers on the carrier signal over a system which can include, but is not limited to, a UTRAN or E-UTRAN system.

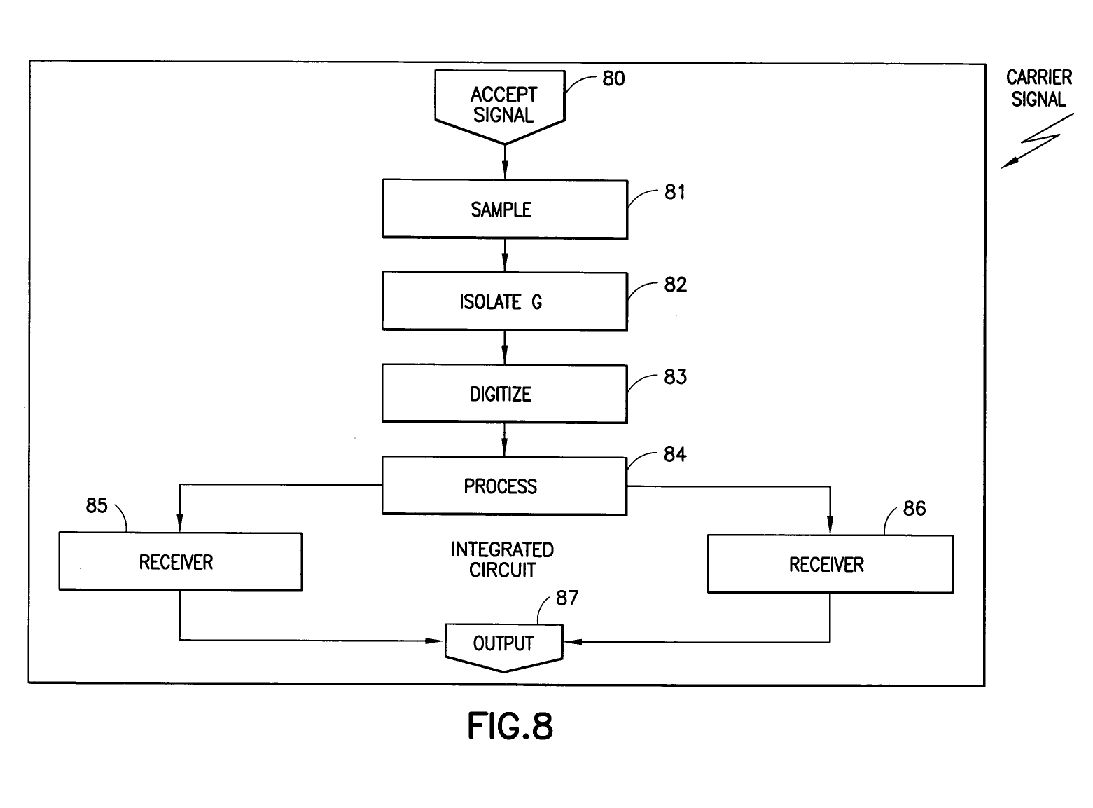

Referring to illustration in FIG. 8 is another exemplary embodiment of the invention, wherein an integrated circuit includes a first circuit operable to accept a carrier signal 80 on a systems bandwidth including a first plurality of sub-carriers comprising a multicast signal allocated on the carrier signal, a second plurality of sub-carriers comprising a unicast signal allocated on the carrier signal, and a third plurality of sub-carriers comprising a guardband signal allocated on the carrier signal; a second circuit operable to sample 81 the pluralities of sub-carriers allocated on the carrier signal and isolate 82 the sub-carriers comprising the guardband from the remaining plurality of sub-carriers comprising the multicast signal and the unicast signal; a third circuit operable to digitize 83 the sampled unicast and multicast signals allocated on the plurality of sub-carriers; a fourth circuit operable to process 84 the digitized signals, where processed signals comprises multicast and unicast signals; a fifth circuit comprising receivers 85-86 operable to receive the processed multicast and unicast signals; and a sixth circuit operable to provide an output 87 for the received signals.

Based on the foregoing it should be apparent that the exemplary embodiments of this invention provide a method, apparatus and computer program product(s) to simultaneously transmit and receive a unicast and a multicast transmission using a substantially OFDM technique, and to also suppress at least ICI by the use of one of a fixed or variable BA guard band interposed between the unicast sub-carriers and the multicast sub-carriers.

In a further non-limiting aspect of the invention, the exemplary embodiments may be applied in the setting of a multi-antenna transmission. So called multiple-input multiple-output (MIMO) methods increase the data rate by adding the possibility to transmit multiple signal streams simultaneously to a user.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. For example, while the exemplary embodiments of the invention have been described above in the context of the UTRAN and E-UTRAN systems, it should be appreciated that the exemplary embodiments of this invention can be applied as well to other types of wireless communications systems, methods and schemes. Further, the exemplary embodiments are not restricted for use with any specific set of bandwidths, or any specific TTI durations. Thus, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

1. A method comprising:
sending a multicast transmission over a first plurality of sub-carriers of a carrier;
sending a unicast transmission over a second plurality of sub-carriers of the carrier; and
interposing a guardband between the first plurality of sub-carriers and the second plurality of sub-carriers of the carrier.

2. The method in claim 1, where the multicast transmission comprises symbols in a frame of the first plurality of sub-carriers, wherein each of the symbols comprises sub-carriers.

3. The method in claim 2, where a long cyclic prefix is applied to the front of the symbols in the frame of the first plurality of sub-carriers.

4. The method in claim 1, where the unicast transmission comprises symbols in a frame of the second plurality of sub-carriers, wherein each of the symbols comprises sub-carriers.

5. The method in claim 4, where a short cyclic prefix is applied to the front of each of the symbols in the frame of the second plurality of sub-carriers

6. The method in claim 1, where the guardband comprises x sub-carriers, where x is fixed or variable from sub-frame to sub-frame.

7. The method in claim 6, where a long cyclic prefix is adaptable for use with the first plurality of sub-carriers to accommodate a change in the value of x.

8. A program of machine-readable instructions, tangibly embodied on an information bearing medium and executable by a digital data processor, to perform actions comprising:
placing a multicast signal on a first plurality of sub-carriers of a carrier,
placing a unicast signal on a second plurality of sub-carriers of the carrier,
interposing a guardband signal between the first plurality of sub-carriers and the second plurality of sub-carriers of the carrier; and
transmitting the multicast signal, the unicast signal and the interposed guardband signal for reception by at least one receiver.

9. The program of claim 8, where the multicast transmission comprises symbols in a frame of the first plurality of sub-carriers, wherein each of the symbols comprises sub-carriers.

10. The program of claim 9, where a long cyclic prefix is applied to the front of each of the symbols in the frame of the first plurality of sub-carriers.

11. The program of claim 8, where the unicast transmission comprises symbols in a frame of the second plurality of sub-carriers, wherein each of the symbols comprises sub-carriers.

12. The program of claim 11, where a short cyclic prefix is applied to the front of each of the symbols in the frame of the second plurality of sub-carriers

13. The program of claim 8, where the guardband comprises x sub-carriers, where x is fixed or variable from sub-frame to sub-frame.

14. The program of claim 13, where a long cyclic prefix is adaptable for use with the first plurality of sub-carriers to accommodate a change in the value of x.

15. A network element comprising:
a processor configured to allocate a multicast signal to a first plurality of sub-carriers on a carrier, to allocate a unicast signal to a second plurality of sub-carriers on the carrier, and to allocate a guardband signal to a third plurality of sub-carriers interposed between the first plurality of sub-carriers and the second plurality of sub-carriers; and
a transmitter coupled to the processor and configured to transmit said first, second and third plurality of sub-carriers.

16. The network element of claim 15, where the multicast transmission comprises symbols in a frame of the first plurality of sub-carriers, wherein each of the symbols comprises sub-carriers.

17. The network element of claim 16, where a long cyclic prefix is applied to the front of each of the symbols in the frame of the first plurality of sub-carriers.

18. The network element of claim 15, where the unicast transmission comprises symbols in a frame of the second plurality of sub-carriers, wherein each of the symbols comprises sub-carriers.

19. The network element of claim 18, where a short cyclic prefix is applied to the front of each of the symbols in the frame of the second plurality of sub-carriers

20. The network element of claim 15, where the guardband comprises x sub-carriers, where x is fixed or variable from sub-frame to sub-frame.

21. The network element of claim 20, where a long cyclic prefix is adaptable for use with the first plurality of sub-carriers to accommodate a change in the value x.

22. The network element of claim 15, where the transmitter transmits multiple signal streams simultaneously to a user.

23. A user equipment comprising:
a receiver configured to receive a plurality of sub-carriers on a carrier;
a processor coupled to the receiver configured to process a first plurality of the sub-carriers allocated to a multicast transmission, to process a second plurality of the sub-carriers allocated to a unicast transmission, and to process a third plurality of sub-carriers that form a guardband interposed between the first plurality of sub-carriers and the second plurality of sub-carriers on the carrier.

24. The user equipment in claim 23, where the multicast transmission comprises symbols in a frame of the first plurality of sub-carriers, wherein each of the symbols comprises sub-carriers.

25. The user equipment in claim 24, where a long cyclic prefix is applied to the front of each of the six symbols in the frame of the first plurality of sub-carriers.

26. The user equipment in claim 23, where the unicast transmission comprises symbols in a frame of the second plurality of sub-carriers, wherein each of the symbols comprises sub-carriers.

27. The user equipment in claim 26, where a short cyclic prefix is applied to the front of each of the symbols in the frame of the second plurality of sub-carriers.

28. The user equipment in claim 23, where the guardband comprises x sub-carriers, and where x is fixed or variable from sub-frame to sub-frame.

29. The user equipment in claim 28, where a long cyclic prefix is adaptable for use with the first plurality of sub-carriers to accommodate a change in the value x.

30. The user equipment in claim 23 where the receiver comprises a unicast receiver and a multicast receiver.

31. The user equipment in claim 30, where the unicast receiver drops a first number of samples corresponding to a short cyclic prefix and accepts a next number of samples for performing a Fast Fourier Transform; and where the multicast receiver drops a first number of samples corresponding to a long cyclic prefix and accepts a next number of samples for performing a Fast Fourier Transform.

32. An integrated circuit comprising:
a first circuit operable to accept a carrier signal comprising:
a first plurality of sub-carriers,
a second plurality of sub-carriers,
a third plurality of sub-carriers comprising a guardband interposed between said first plurality of sub-carriers and said second plurality of sub-carriers, where the guardband comprises x sub-carriers, where x is fixed or variable from sub-frame to sub-frame;
a second circuit operable to sample the sub-carriers on the carrier signal, comprising isolating the x sub-carriers comprising the guardband;
a third circuit operable to digitize the sampled sub-carriers;
a fourth circuit operable to process the digitized samples; and
a fifth circuit comprising at least one signal type receiver operable to receive the processed signals.

33. The integrated circuit of claim 32, embodied in a user equipment.

34. An electronic device comprising:
first circuit means for allocating a first plurality of sub-carriers comprising a multicast signal to a carrier signal;
second circuit means for allocating a second plurality of sub-carriers comprising a unicast signal to the carrier signal;
third circuit means for allocating a third plurality of sub-carriers comprising a guardband signal interposed between said first plurality of sub-carriers and said second plurality of sub-carriers, where the guardband comprises x sub-carriers, where x is fixed or variable from sub-frame to sub-frame; and
fourth circuit means for transmitting said first, second and third plurality of sub-carriers on said carrier signal.

35. The electronic device of claim 34, embodied in a Node B.
